(19) United States
(12) Patent Application Publication
(10) Pub. No.: US 2008/0263591 A1
(43) Pub. Date: Oct. 23, 2008

(54) Content viewing session

(75) Inventor: David L. de Heer, Woodside, CA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/788,998

(22) Filed: Apr. 23, 2007

(51) Int. Cl. H04N 5/00

(52) U.S. Cl. 725/38

(57) ABSTRACT

Techniques are described to provide a content viewing session. In an implementation, an input is received that selects a length of a viewing session for content to be output at the client. The viewing session having the selected length is populated using a plurality of content that is likely to be of interest to a user of the client.

### BACKGROUND

One of the time-honored traditions of television viewing has been to tune to a particular channel at a desired time and watch that channel from the evening news to late-night shows. This was epitomized by decades or more of branded programming that was arranged to maintain the user's attention for hours, such as “Must See Thursdays” on NBC. By providing a “couch potato” experience, the content providers and advertisers were assured continuity of viewing, which helped to provide opportunities to advertisers and drive the revenue model of the content provider.

As technology continued to evolve, however, the couch potato experience was and continues to be replaced by a “lean forward” experience of channel surfing. For example, a user may channel surf through broadcast content as well as on-demand content obtained from digital video recorders, video-on-demand systems from network operators, and so on. In such an experience, selected content by a user involved the user's manual navigation to particular items of content and a positive decision to view the particular content. Thus, these techniques required a signification amount of energy which is contrary to the time-honored traditions of passive viewing.

### SUMMARY

Techniques are described to provide a content viewing session. In an implementation, an input is received that selects a length of a viewing session for content to be output at a client. The viewing session having the selected length is populated using a plurality of content that is likely to be of interest to a user of the client.

In another implementation, a template is exposed of a viewing session for content to be output at a client. The template is populated using a plurality of content automatically and without user intervention in response to an input that selects the template.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an exemplary implementation that is operable to provide a content viewing session.

FIG. 2 is an illustration of a system showing a network operator and a client of FIG. 1 in greater detail.

FIG. 3 is an illustration of an exemplary implementation in which a display device of the client of FIG. 2 is shown as outputting a session user interface.

FIG. 4 is a flow diagram depicting a procedure in an exemplary implementation in which a viewing session is selected to have a particular length which is populated with content that is likely to be of interest to a user.

FIG. 5 is a flow diagram depicting a procedure in an exemplary implementation in which templates are exposed and populated automatically and without user intervention to include television programs and advertising.

### DETAILED DESCRIPTION

Overview One of the time-honored traditions of television viewing has been the “couch potato” experience in which a user tuned to a particular channel at a desired time and watched that channel from the evening news to late-night shows. However, as technology continues to evolve that experience has been replaced with a “lean forward” experience of channel surfing including surfing through broadcast content as well as on-demand content obtained from digital video recorders, video-on-demand systems from network operators, and so on. This surfing involved significant participation on the part of the user and therefore ran contrary to a desired “lean back” experience.

Techniques are described to provide a content viewing session that provides a “lean back” experience. The techniques, for instance, may leverage broadcast and on-demand systems to provide content from a wide range of sources, such as from digital video recorders and video-on-demand (VOD) systems, to provide a “rich” experience that may be targeted to include content that is likely to be of interest to a user.

The user, for example, may sit down on a couch in a household and select an option to watch television programming for the next four hours. A client (e.g., a set-top box) which receives this request may then create a viewing session having the desired length that includes content based on the preferences of the user. For instance, the viewing session may be automatically created to include television programming and commercials that are considered relevant to the television programming, e.g., beer commercials for a sporting event. In an implementation, this selection and output is performed automatically and without user intervention such that the user does not individually select the particular content, but rather provides an input regarding overall desires of the viewing session. For example, this selection may be performed through use of one or more templates which define overall parameters of a viewing session, e.g., such as for a two hour sports/action template to include sports programming with a television sit-com. Further discussion of the selection of content for a viewing session and the use of templates may be found in relation to the following figures.

In the following discussion, an exemplary environment is first described that is operable to perform techniques to provide a content viewing session. Exemplary procedures are then described that may be employed in the exemplary environment, as well as in other environments. Although these techniques are described as employed within a television environment in the following discussion, it should be readily apparent that these techniques may be incorporated within a variety of environments without departing from the spirit and scope thereof.

Exemplary Environment

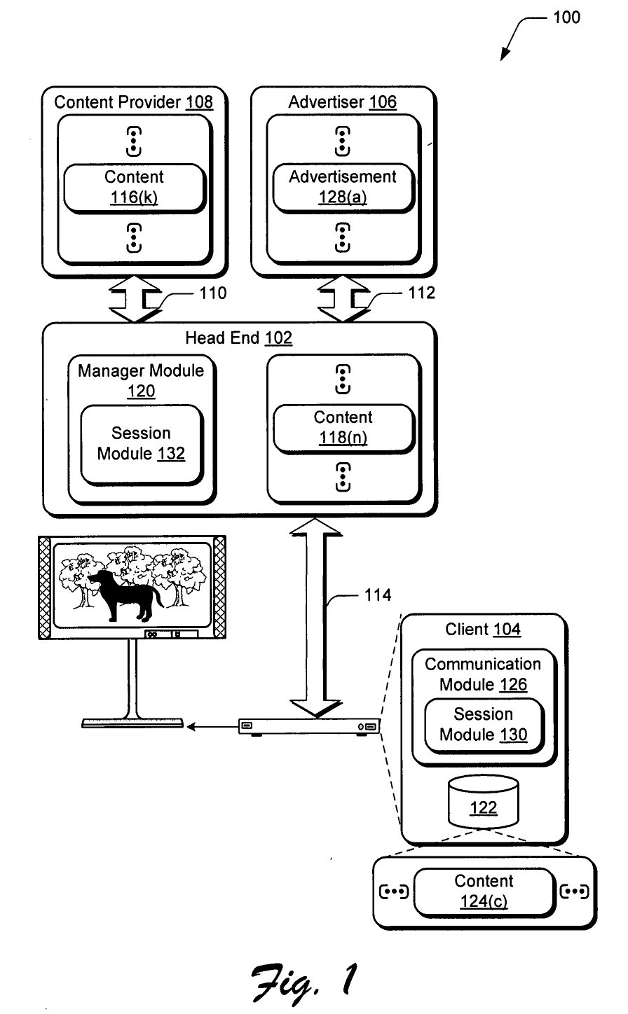

FIG. 1 is an illustration of an environment 100 in an exemplary implementation that is operable to provide a content viewing session. The illustrated environment 100 includes a head end 102 (e.g., which may be incorporated as part of a network operator), a client 104, an advertiser 106 and a content provider 108 that are communicatively coupled, one to another, via network connections 110, 112, 114. In the following discussion, the head end 102, the client 104, the advertiser 106 and the content provider 108 may be representative of one or more entities, and therefore reference may be made to a single entity (e.g., the client 104) or multiple entities (e.g., the clients 104, the plurality of clients 104, and so on). Additionally, although a plurality of network connections 110-114 are shown separately, the network connections 110-114 may be representative of network connections achieved using a single network or multiple networks. For example, network connection 114 may be representative of a broadcast network with back-channel communication, an Internet Protocol (IP) network, and so on.

The client 104 may be configured in a variety of ways. For example, the client 104 may be configured as a computer that is capable of communicating over the network connection 114, such as a desktop computer, a mobile station, an entertainment appliance, a set-top box communicatively coupled to a display device as illustrated, a wireless phone, and so forth. For purposes of the following discussion, the client 104 may also relate to a person and/or entity that operate the client. In other words, client 104 may describe a logical client that includes a user, software and/or a machine.

The content provider 108 includes one or more items of content 116(k), where “k” can be any integer from 1 to “K”. The content 116(k) may include a variety of data, such as television programming, video-on-demand (VOD) files, one or more results of remote application processing, and so on. The content 116(k) is communicated over the network connection 110 to the head end 102.

Content 116(k) communicated via the network connection 110 is received by the head end 102 and may be stored as one or more items of content 118(n), where “n” can be any integer from “1” to “N”. The content 118(n) may be the same as or different from the content 116(k) received from the content provider 108. The content 118(n), for instance, may include additional data for broadcast to the client 104. For example, the content 118(n) may include electronic program guide (EPG) data from an EPG database for broadcast to the client 104 utilizing a carousel file system. The carousel file system repeatedly broadcasts the EPG data over an out-of-band (OOB) channel to the client 104 over the network connection 114. Distribution from the head end 102 to the client 104 may be accommodated in a number of ways, including cable, radio frequency (RF), microwave, digital subscriber line (DSL), and satellite.

The client 104, as previously stated, may be configured in a variety of ways to receive the content 118(n) over the network connection 114. The client 104 typically includes hardware and software to transport and decrypt content 118(n) received from the head end 102 for rendering by the illustrated display device. Although a display device is shown, a variety of other output devices are also contemplated, such as speakers.

The head end 102 is illustrated as including a manager module 120. The manager module 120 is representative of functionality to configure content 118(n) for output (e.g., streaming) over the network connection 114 to the client 104. The manager module 120, for instance, may configure content 116(k) received from the content provider 108 to be suitable for transmission over the network connection 114, such as to “packetize” the content for distribution over the Internet, configuration for a particular broadcast channel, map the content 116(k) to particular channels, and so on. Thus, in the environment 100 of FIG. 1, the content provider 108 may broadcast the content 116(k) over a network connection 110 to a multiplicity of network operators, an example of which is illustrated as head end 102. The head end 102 may then stream the content 118(n) over a network connection to a multitude of clients, an example of which is illustrated as client 104.

In another example, the content included in the environment 100 may also be configured to be provided “on demand” and thus may be referred to as “on-demand content”, which may be provided locally at the client 104 (e.g., in a DVR example) and/or remotely over the network connection 114 (e.g., as VOD or a network DVR). The client 104, for example, may include digital video recorder (DVR) functionality. The illustrated client 104 includes a storage device 122 to record content 118(n) as content 124(c) (where “c” can be any integer from one to “C”) received via the network connection 114 for output to and rendering by the display device. The storage device 122 may be configured in a variety of ways, such as a hard disk drive, a removable computer-readable medium (e.g., a writable digital video disc), and so on. Thus, content 124(c) that is stored in the storage device 122 of the client 104 may be copies of the content 118(n) that was streamed from the head end 102. In another example, content 124(c) may be obtained from a variety of other sources, such as from a computer-readable medium that is accessed by the client 104, and so on.

Continuing now with the “on-demand” example, the client 104 in the illustrated example includes a communication module 126 that is executable on the client 104 to control content playback on the client 104, such as through the use of one or more “command modes”. The command modes may provide non-linear playback of the content 124(c) (i.e., time shift the playback of the content 124(c)) such as pause, rewind, fast forward, slow motion playback, and the like. For example, during a pause, the client 104 may continue to record the content 118(n) in the storage device 122 as content 124(c). The client 104, through execution of the communication module 126, may then playback the content 124(c) from the storage device 122, starting at the point in time the content 124(c) was paused, while continuing to record the currently-broadcast content 118(n) in the storage device 122 from the head end 102.

The “on-demand” content may also be obtained remotely via a network, e.g., the network connection 114. For instance, the content 118(n) at the head end 102 may also be representative of on-demand content, such as video-on-demand (VOD) content that is streamed to the client 104 when requested, such as movies, sporting events, and so on. For example, the head end 102 may execute the manager module 120 to provide a VOD system such that the content provider 108 supplies content 116(k) in the form of complete content files to the head end 102. The head end 102 may then store the content 116(k) as content 118(n). The client 104 may then request playback of desired content 118(n) by contacting the head end 102 (e.g., a VOD server) and requesting a feed of the desired content.

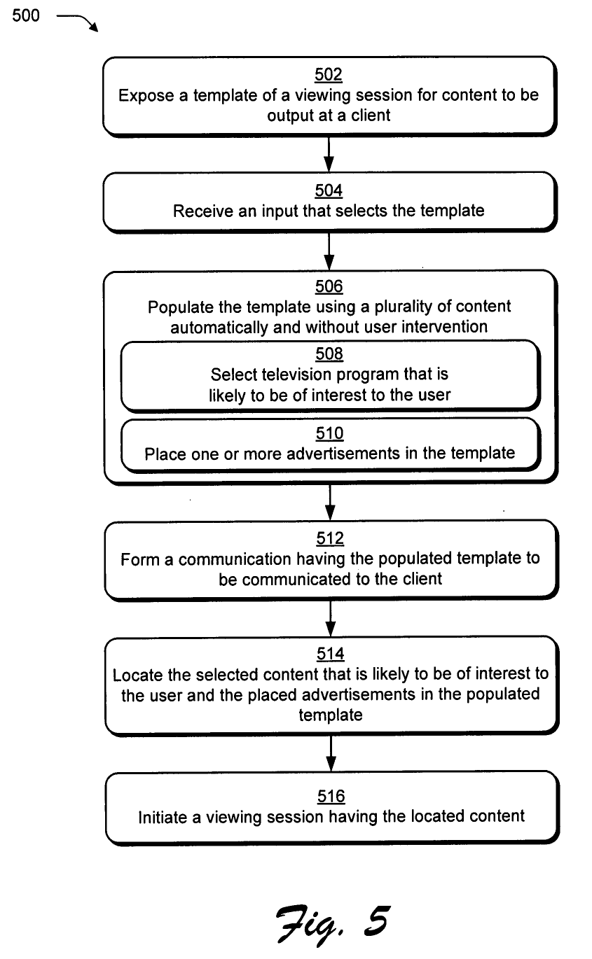

In another instance, the content 118(n) may further be representative of content (e.g., content 116(k)) that was recorded by the head end 102 in response to a request from the client 104, in what may be referred to as a network DVR example. Like VOD, the recorded content 118(n) may then be streamed to the client 104 when requested. Interaction with the content 118(n) by the client 104 may be similar to interaction that may be performed when the content 124(c) is stored locally in the storage device 122. It should be readily apparent that a wide variety of other types of on-demand content are also contemplated. For example, one or more of the advertisements 128(a) (where “a” can be any integer form one to “A”) may also be considered content and provided to the head end 102 and/or the client 104 “on demand”, further discussion of which may be found in relation to FIG. 5.

The environment 100 is further illustrated as including session modules 130, 132 that are included on the client 104 and the head end 102 respectively to indicate that functionality represented by these modules may be implemented by one or more modules and/or devices in the environment 100. The session modules 130, 132 are representative of functionality to create and output a content viewing session. For example, the session modules 130, 132 may be configured to automatically create a viewing session without user intervention when the user provides an input to initiate the session. The user, for instance, may interact with the session module 130 and select an option via a graphical user interface to watch television programming for a particular amount of time, such as two hours. The session module 130, alone or in combination with session module 132, may then output a viewing session automatically and without further user interaction, such as by populating the viewing session with content 118(n), 124(c) based on the preferences of the user.

The content that is used to populate the viewing session may be obtained from a variety of different sources, such as via a broadcast from the head end 102 or as “on demand” content 124(c) stored locally at the client 104 in a DVR example, content 118(n) available remotely from the head end 102 as in a NDVR or VOD examples, and so on. Additionally, cost considerations may be employed by the session modules 130, 132 to decide from where the content should be obtained. For example, the session module 130 may first determine whether the content is available without additional cost (e.g., “for free”) from the storage device 122, from a broadcast or for “free” from a VOD system. If not, the session module 130 may locate the content (e.g., content 118(n)) and access it for a fee, further discussion of which may be found in relation to FIG. 5. A variety of techniques may be employed to provide a viewing session, examples of which are further described in relation to the following figures.

It should be noted that one or more of the entities shown in FIG. 1 may be further divided (e.g., the head end 102 may be implemented by a plurality of servers in a distributed computing system), combined (e.g., the head end 102 and the advertiser 106 may be combined), and so on and thus the environment 100 of FIG. 1 is illustrative of one of a plurality of different environments that may employ the described techniques.

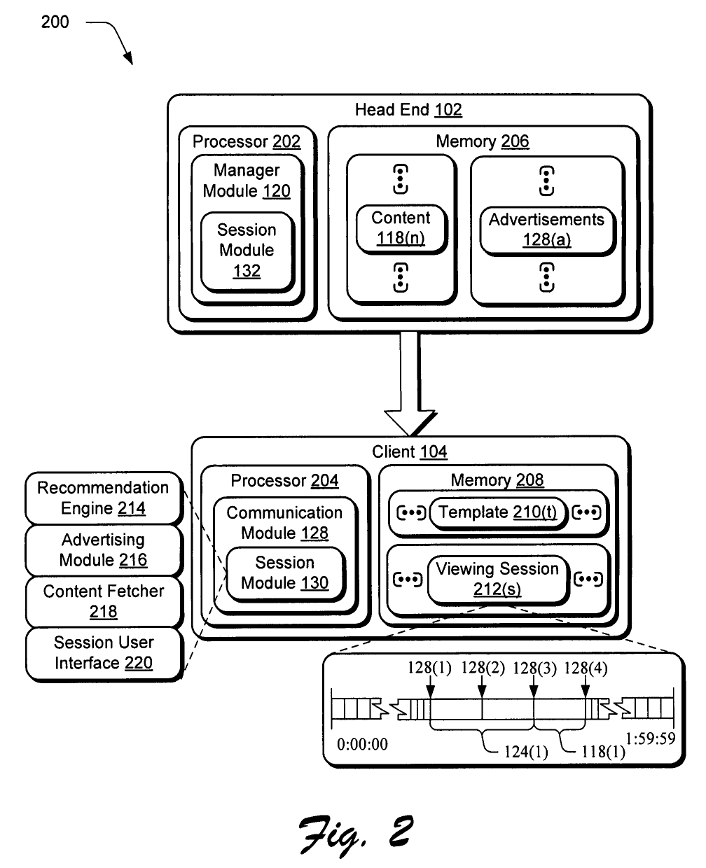

FIG. 2 depicts a system 200 in an exemplary implementation showing the head end 102 and the client 104 in greater detail. The head end 102 and the client 104 are both illustrated as devices having respective processors 202, 204 and memory 206, 208. Processors are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions. Additionally, although a single memory 206, 208 is shown, respectively, for the head end 102 and the client 104, a wide variety of types and combinations of memory may be employed, such as random access memory (RAM), hard disk memory, removable medium memory, and other types of computer-readable media.

The session module 130 is shown as part of the communication module 126 which is illustrated as being executed on the processor 204 and is storable in memory 208. The session module 130 is this example is configured to use one or more templates 210(t) (where “t” can be any integer from one to “T”) to generate one or more viewing sessions 212(s) (where “s” can be any integer from one to “S”) having the content previously described in relation to FIG. 1.

Viewing session 212(s), for instance, is further illustrated in FIG. 2 as having a length of two hours that references content 124(1) from storage 122 of the client 104 and content 118(1) obtained from content 118(n) stored in memory 206 at the head end 102, e.g., via broadcast, VOD, NDVR, and so on. The viewing session 212(s) is further illustrated as including content configured as advertisements 128(1), 128(2), 128(3), 128(4), which may be obtained from the advertisements 128(a) stored in memory 206 and the head end 102.

To generate the viewing session 212(s), the session module 130 may include functionality illustrated as a recommendation engine 214, an advertising module 216, a content fetcher 218 and a session user interface 220. Although the recommendation engine 214, the advertising module 216, the content fetcher 218 and the session user interface 220 are illustrated as incorporated within the session module 130 of the client 104 in FIG. 2, it should also be apparent that all or a part of the respective functionality may also be employed by the session module 132 of the head end 102.

The recommendation engine 124 is representative of functionality that may be employed to determine which content is likely to be of interest to a user of the client 104. A variety of different techniques may be employed to make this determination. For example, the recommendation engine 214 may employ a technology to automatically generate recommendations based on television viewing history data that is gathered for multiple clients. The television viewing history data may identify broadcast television programs that are watched using the clients. For instance, VOD data may be gathered that identifies VOD content that is purchased or viewed using the clients. Weighted associations may then be generated between the television data and the VOD data to represent the likelihood that a viewer who watches a particular television program will also likely wish to purchase a particular VOD, view a television program from a DVR, stream content from a NDVR, and so on.

The associations, for instance, may be weighted based on a percentage of viewers who purchase or watch particular content. In an alternate implementation, the associations are weighted according to a lift algorithm, which is used to calculate a ratio of probabilities. The ratio is defined as the conditional probability that a viewer will wish to consume particular content given that the user has already watched other particular content divided by the probability that any viewer will wish to consume the particular content.

In another example, the recommendation engine 214 may employ a data mining engine to generate a decision tree for each item of content using viewing data to generate tree splitting criteria, e.g., a probabilistic classification tree using a Bayesian score as a splitting criteria. In a further example, the recommendation engine 214 may employ the data mining engine to apply association rules algorithms to generate probabilities that particular content may be of interest given that particular combinations of content (e.g., television programs) have been watched. After the associations are generated, recommendations may be generated by comparing the associations with viewing history data that is associated with a particular user. A variety of different examples are also contemplated.

The advertising module 216 is representative of functionality to include the advertisements 128(1)-128(4) in the viewing session 212(s). The advertising module 216, for instance, may employ techniques similar to the recommendation engine 214 to locate advertisements 128(1)-128(4) that have an affinity to the content 124(1), 118(1) in the viewing session, such as to include beer commercials with a sporting event. In another instance, the advertising module 216 may employ techniques to compare metadata associated with content 124(1), 118(1) with metadata associated with available advertisements 128(a) to determine which advertisements (e.g., 128(1)-128(4)) to associate with which content. Comparisons may be based on, for example, content quality, content duration, time sensitivity of advertisements, positive keyword associations, and/or negative keyword associations. Further, the advertising module 216 may also determine “where” to include the advertisements, such as at a beginning or end of an output to content, during an ad avail within the output of the content, where to place an advertisements within the ad avail, and so on. A variety of other examples are also contemplated, further discussion of which may be found in relation to FIG. 5.

The content fetcher 218 is representative of functionality to obtain content identified in the viewing session 212(s). For example, the content fetcher 218 may be configured to locate the content 124(1) via a broadcast, VOD, NDVR, and so on from the head end 102. The content fetcher 218 may also be configured to locate content 118(1) locally at the client 104, such as from the storage device 122.

The content fetcher 218 may also employ techniques that take into account cost when locating content. For example, the content fetcher 218 may first “look” for content from sources that do not involve additional cost, such as from a broadcast, from stored DVR content, and so on. When the content fetcher 218 is not able to obtain such content, the content fetcher 218 may look at fee services, such as VOD that is provided for a fee, downloads via the Internet from a website, and so on. Further discussion of fee considerations which may be found in relation to FIG. 5.

The session module 130 may also provide a session user interface 220 that provides a user with selection parameters that may be used to create a session, such as length of viewing session 212(s), content mix, parental controls, cost constraints for payment-based content, and so on. The session user interface 220 may also be used to create and/or select templates 210(t) used to generate the viewing session 212(s), further discussion of which may be found in relation to the following figure.

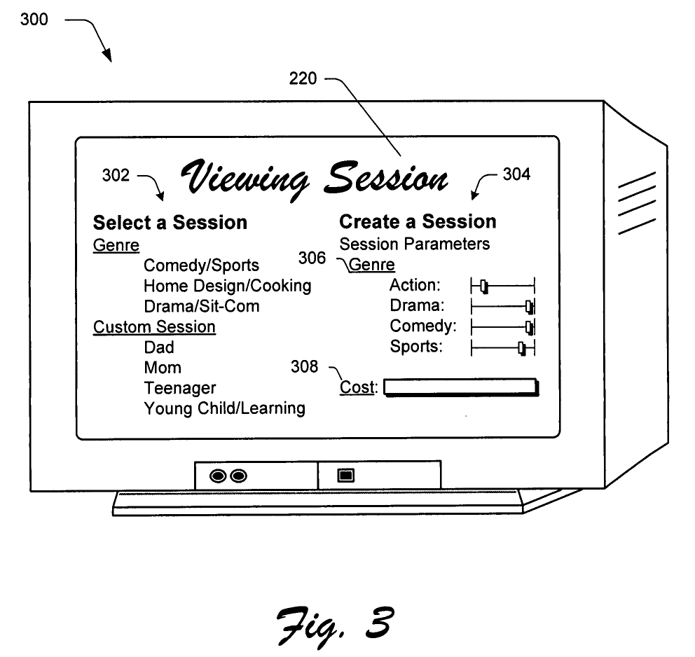

FIG. 3 depicts an exemplary implementation 300 in which a display device of a client is shown as outputting the session user interface 220 of FIG. 2. The user interface 220 is configured to provide a wide variety of functionality to a user, including selecting a session 302 and creating of a session 304.

The user, for instance, may use an input device (e.g., a cursor control device or remote control) to select a preconfigured template which is then populated automatically with content that is likely to be of interest of a user. As shown in the illustration of FIG. 2, a user may select between combinations of genres which are shown as “Comedy/Sports”, “Home Design/Cooking” and “Drama/Sit-Com”. These templates may therefore provide a basis to select content that may be of interest to the user as previously described in relation to the recommendation engine 214 of FIG. 2. In this way, a user may make a single selection (e.g., select each of these templates with a single “click”) and receive content that is likely to be of interest of the user, thus providing a user with a “lean back” experience.

The user may also use the functionality of the session user interface 220 to create a session 304. For example, the user may use slider bars as illustrated to assign weights to session parameters, an example of which is illustrated as genre 306. The user may also enter a desired maximum cost 308 to be spent on the session, such as an amount of money that is permitted to be used to purchase content. A variety of other session parameters are also contemplated such as selection of length of the viewing session, content mix, parental controls, and so on. Sessions created using this functionality may then be saved for later access, examples of which are illustrated as the “Custom Sessions” in the user interface 220 shown as “Dad” and “Mom”.

Targeted sessions may also be obtained, such as from a third-party service based on data collected from a plurality of clients as previously described in relation to the recommendation engine 214, examples of which are illustrated as “Teenager” and “Young Child/Learning”. In an implementation, the third-party service may provide these templates for a fee, provide them free of charge by including targeted advertisements 128(a) provided by the third-party service, and so on. Further discussion of the functionality of the session user interface 220 may be found in relation to the following procedures.

Generally, any of the functions described herein can be implemented using software, firmware, hardware (e.g., fixed-logic circuitry), manual processing, or a combination of these implementations. The terms “module”, “functionality” and “logic” as used herein generally represent software, firmware, hardware, or a combination thereof. In the case of a software implementation, for instance, the module, functionality, or logic represents program code that performs specified tasks when executed on a processor (e.g., CPU or CPUs). The program code can be stored in one or more computer-readable memory devices. The features of the techniques to generate a content viewing session are platform-independent, meaning that the techniques may be implemented on a variety of commercial computing platforms having a variety of processors.

Exemplary Procedures

The following discussion describes techniques that may be implemented utilizing the previously described environment, systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1, the system 200 of FIG. 2 and the user interface 220 of FIG. 3.

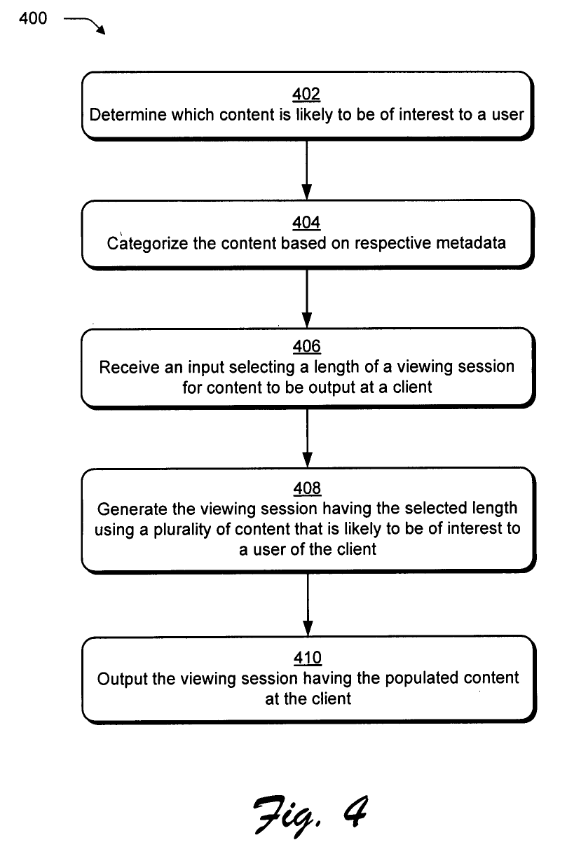

FIG. 4 depicts a procedure 400 in an exemplary implementation in which a viewing session is selected to have a particular length which is populated with content that is likely to be of interest to a user. A determination is made as to which content is likely to be of interest to a user (block 402). The determination, for instance, may be based on user preferences of the user that are input manually by the user, observed by monitoring user interaction with particular items of content as previously described in relation to FIG. 2, and so on. For example, this determination may be used to generate a list of content that is likely to be of relatively “high” interest to the user.

The content is then categorized based on respective metadata (block 404). Continuing with the previous example, the content may include metadata that describes characteristics of the content, such as author, title, genre, length, plot, actors and so on. These categories of interest may then be used to select content, as further described below.

An input is received selecting a length of a viewing session for content to be output at a client (block 406). The user, for instance, may interact with a session user interface and specify a template having a predetermined length and/or may manually input a desired amount of viewing time. The viewing session having the selected length is then generated using a plurality of content that is likely to be of interest to a user of the client (block 408).

For example, the user may select a sports/comedy template. Highly ranked content that has been categorized into those genres may then be used to populate the template thereby generating the viewing session. A variety of other session parameters and content metadata may also be used to describe content for inclusion in the template.

The viewing session having the populated content is then output at the client (block 410). For example, the user may be automatically navigated to a particular channel to view the viewing session. Additional examples are described in relation to the following figure.

FIG. 5 depicts a procedure 500 in an exemplary implementation in which templates are exposed and populated automatically and without user intervention to include television programs and advertising. A template is exposed of a viewing session for content to be output at a client (block 502). The template, for instance, may be one of a plurality of templates, an example of which is shown in FIG. 3.

An input is received that selects the template (block 504). The user, for instance, may use a remote control to highlight and select a “Drama/Sit-Com” template under “Genre” in the user interface 220 depicted in FIG. 3.

The template is populated using a plurality of content automatically and without user intervention (block 506). The content, for instance, may include television programming that is likely to be of interest to the user (block 508).

Populating the template with content may also include placement of one or more advertisements in the template (block 510). The advertisements may be targeted using the techniques previously described. Further, the advertisements may be used to support a revenue model to offset the cost to users to access the content, such as to offset “fee” content by including advertisements. As previously described, the advertisements may be run before or after the viewing session, at times between the output of individual items of content within a session, at ad avails identified within individual items of content, and so on.

A communication is formed having the populated template to be communicated to the client (block 512). The communication, for instance, may be configured as an extensible markup language (XML) document which includes a content identifier, an order in which the content is to be output and/or a location of where the content may be obtained, e.g., network address, channel, whether the content may be available within the storage device 122 of the client 104, and so on.

The selected content that is likely to be of interest to the user and the placed advertisements in the populated template are located (block 514). For example, the populated template may include a content identifier that is used by the session module 130 to locate the content in a broadcast, in local storage, in a VOD system, via a website, and so on. Fee considerations may also be employed by the session module 130 when locating content, such as to first attempt to locate content from sources in which the content is available without additional charge. If the content is not so available, the session module 130 may attempt to locate the content from “pay” sites, such as VOD for a fee, websites, and so on. Once the content is located, a viewing session having the located content is initiated (block 516). It should be noted that in an implementation the viewing session is initiated without further prompting from the user. Other implementations are also contemplated in which a user is provided an opportunity to “start” the session once it is generated, such as to view the content selected and approve/deny the selections before output. A variety of other examples are also contemplated.

### CONCLUSION

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method comprising:
receiving an input selecting a length of a viewing session for content to be output at a client; and
generating the viewing session having the selected length using a plurality of content that is likely to be of interest to a user of the client.

2. A method as described in claim 1, wherein the receiving is performed before the generating.

3. A method as described in claim 1, wherein the input is receivable via a graphical user interface output via the client.

4. A method as described in claim 3, wherein the graphical user interface provides a plurality of options, each of which corresponds to a different respective said length.

5. A method as described in claim 1, wherein the generating includes:
locating a template having a plurality of references to different types of content;
finding particular items of content having the different types based on the references; and
providing references to locations of the found particular items of content.

6. A method as described in claim 5, wherein at least one of the found particular items of content is obtainable from storage local to the client.

7. A method as described in claim 1, wherein the plurality of content includes one or more advertisements and one or more television programs.

8. A method comprising:
exposing a template of a viewing session for content to be output at a client; and
populating the template using a plurality of content automatically and without user intervention in response to an input that selects the template.

9. A method as described in claim 8, wherein the exposing is performed such that a plurality of said templates is concurrently exposed in a single user interface.

10. A method as described in claim 8, wherein the exposing is performed such that the template is exposed through navigation to a particular one of a plurality of channels.

11. A method as described in claim 10, wherein two or more said channels are each assigned a respective said template.

12. A method as described in claim 8, wherein the populating includes placement of one or more advertisements with one or more other said content that is not advertisements.

13. A method as described in claim 12, wherein the one or more advertisements are selected from a plurality of said advertisements based on an affinity identified with the one or more other said content that is not advertisements.

14. A method as described in claim 8, wherein the populating is performed such that one or more said content are selected that is likely to be of interest to the user.

15. One or more computer-readable media comprising instructions that are executable to locate content referenced in a template that specifies a viewing session that was populated automatically based on user preferences, wherein the content is located based at least in part on cost.

16. One or more computer-readable media as described in claim 15, wherein the content is located based at least in part on cost by determining whether the content is currently available without additional cost, and if not, locating the content in a video-on-demand (VOD) system.

17. One or more computer-readable media as described in claim 15, wherein one or more of said content is stored locally on a client that accesses the computer-readable media.

18. One or more computer-readable media as described in claim 15, wherein one or more of said content is available remotely over a network connection from a head end.

19. One or more computer-readable media as described in claim 15, wherein the content includes advertisements and television programs.

20. One or more computer-readable media as described in claim 15, wherein the instructions are further executable to cause output of the content.
